(19) United States
(12) Patent Application Publication
(10) Pub. No.: US 2019/0123352 A1
(43) Pub. Date: Apr. 25, 2019

(54) ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Youngsan KO, Yongin-si (KR); Minjae KIM, Yongin-si (KR); Kijun KIM, Yongin-si (KR); Duckhyun KIM, Yongin-si (KR); Jinhee KIM, Yongin-si (KR); Woonsuk JANG, Yongin-si (KR); Hyeoksu JANG, Yongin-si (KR)

(21) Appl. No.: 16/158,226

(22) Filed: Oct. 11, 2018

(30) Foreign Application Priority Data
Oct. 19, 2017 (KR) 10-2017-0136113

(51) Int. Cl. H01M 4/583; H01M 10/052; H01M 4/38

(52) U.S. Cl. CPC H01M 4/583; H01M 2004/021; H01M 4/386; H01M 10/052

(57) ABSTRACT

An electrode for a rechargeable lithium battery includes a current collector and an active material layer on the current collector, the active material layer including an active material, carbon nanotubes, and nanocarbon, wherein the carbon nanotubes have an average length of about 40 μm to about 250 μm, and the nanocarbon has an average particle diameter of about 5 nm to about 100 nm.

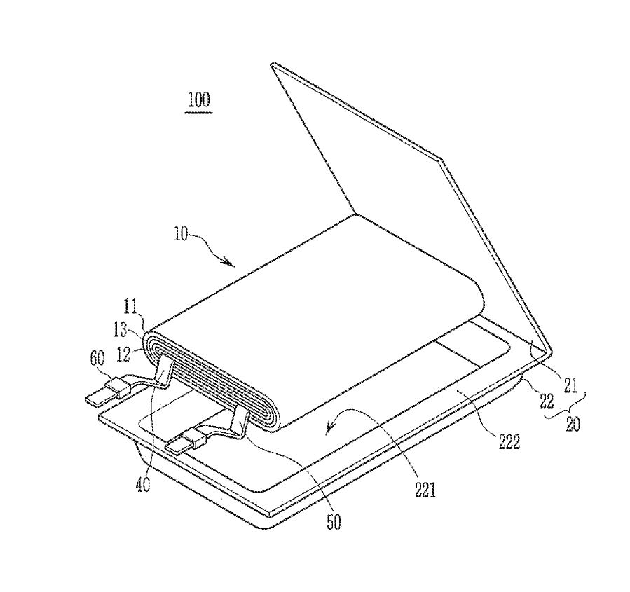

### CROSS-REFERENCE TO RELATED APPLICATION

This application claims priority to and the benefit of Korean Patent Application No. 10-2017-0136113 filed in the Korean Intellectual Property Office on Oct. 19, 2017, the entire contents of which are incorporated herein by reference.

### BACKGROUND

### 1. Field

Embodiments of this disclosure relate to an electrode for a rechargeable lithium battery and a rechargeable lithium battery including the same.

### 2. Description of the Related Art

A rechargeable lithium battery may be operated for a long time as well as have a high driving voltage and high energy density, and thus, may satisfy complicated requirements for a diverse group and combination of devices. Recently, an effort to further develop rechargeable lithium battery technology to expand its application to power storage and the like, as well as electrical vehicles, has been actively made.

Accordingly, various researches have been conducted on a rechargeable lithium battery having high-rate charge/discharge characteristics as well as improved low temperature characteristics, storage characteristics at a high temperature, and cycle-life characteristics at a high temperature.

### SUMMARY

Embodiments of this disclosure provide an electrode for a rechargeable lithium battery having improved specific resistivity characteristics of an electrode and high-rate charge/discharge characteristics as well as improved low temperature characteristics, storage characteristics at a high temperature and cycle-life characteristics at a high temperature, and a rechargeable lithium battery including the same.

In one aspect of an embodiment, this disclosure provides an electrode for a rechargeable lithium battery including a current collector and an active material layer on the current collector, the active material layer including an active material, carbon nanotubes, and nanocarbon. The carbon nanotubes have an average length of about 40 μm to about 250 μm and the nanocarbon has an average particle diameter of about 5 nm to about 100 nm.

In another aspect of an embodiment, this disclosure provides a rechargeable lithium battery including a positive electrode, a negative electrode, a separator between the positive electrode and the negative electrode, and an electrolyte solution, wherein at least one of the positive electrode and the negative electrode is the above electrode for rechargeable lithium battery.

The electrode for rechargeable lithium battery according to an embodiment of this disclosure may remarkably decrease specific resistivity of an electrode. In addition, when the electrode is applied to a rechargeable lithium battery, resistance of the rechargeable lithium battery may be decreased, and thus the rechargeable lithium battery may show very excellent high-rate charge/discharge characteristics.

Furthermore, when the electrode for rechargeable lithium battery according to this disclosure is applied to a rechargeable lithium battery, low temperature characteristics, storage characteristics at a high temperature, and cycle-life characteristics at a high temperature may be further improved.

### BRIEF DESCRIPTION OF THE DRAWING

The accompanying drawings, together with the specification, illustrate embodiments of the subject matter of the present disclosure, and, together with the description, serve to explain principles of embodiments of the subject matter of the present disclosure.

The accompanying drawing is a schematic view showing a structure of a rechargeable lithium battery according to an embodiment of this disclosure.

### DETAILED DESCRIPTION

The present disclosure will be described more fully hereinafter with reference to the accompanying drawing, in which an exemplary embodiment of the present disclosure are shown. The subject matter of the present disclosure may be modified in various different ways, all without departing from the spirit or scope of the present disclosure.

In the accompanying drawing, parts having no relationship with the description are omitted for clarity of the embodiments, and the same or similar constituent elements are indicated by the same reference numerals throughout the present specification.

The size and thickness of each constituent element as shown in the accompanying drawing may be exaggerated for better understanding and ease of description, and this disclosure is not necessarily limited to the sizes and thicknesses as shown.

In addition, unless explicitly described to the contrary, the word “comprise” and variations such as “comprises” or “comprising”, will be understood to imply the inclusion of stated elements but not the exclusion of any other elements.

An electrode for rechargeable lithium battery according to an embodiment of this disclosure includes a current collector and an active material layer on the current collector, wherein the active material layer includes an active material, carbon nanotubes, and nanocarbon.

In the present example embodiment, the carbon nanotubes have an average length of about 40 μm to about 250 μm and the nanocarbon has an average particle diameter of about 5 nm to about 100 nm.

For example, the carbon nanotubes may have an average length of about 40 μm to about 250 μm, for example, about 70 μm to about 250 μm, or about 100 μm to about 250 μm. In addition, when the carbon nanotubes have an average length of greater than or equal to about 40 μm, an active material layer including the same may reduce resistance of an electrode, and thus improve performance of a rechargeable battery manufactured by applying the same. Furthermore, when the carbon nanotubes have an average length of less than or equal to about 250 μm, resistance of the electrode and concurrently (e.g., simultaneously), resistance of a rechargeable battery may be reduced, and high-rate charge and discharge performance of the rechargeable battery may be improved. In addition, when the carbon nanotubes have an average length within the foregoing range, high-rate charge and discharge performance of the rechargeable battery may be improved, and concurrently (e.g., simultaneously), the rechargeable battery may have a long cycle-life. The average length of the carbon nanotubes may be maintained in the negative electrode.

On the other hand, the carbon nanotubes may have an average diameter of about 1 nm to about 20 nm, for example, about 5 nm to about 20 nm or about 15 nm to about 20 nm. When the carbon nanotubes have an average diameter of greater than or equal to about 1 nm, dispersion of a slurry including the carbon nanotubes may be improved. In addition, when the carbon nanotubes have an average diameter of less than or equal to about 20 nm, resistance of an electrode may be reduced.

Furthermore, the carbon nanotubes may have a volume density (bulk density) of less than or equal to about 0.1 g/cm³, for example, in a range of about 0.001 g/cm³ to about 0.1 g/cm³, or about 0.01 g/cm³ to about 0.1 g/cm³. When the carbon nanotubes have a volume density within the foregoing ranges, resistance characteristics, low temperature characteristics, discharge characteristics, storage characteristics at a high temperature, and the like of a rechargeable lithium battery manufactured by using the same may be overall improved.

In this disclosure, the carbon nanotubes may be one, two, or more selected from single-walled carbon nanotubes, double-walled carbon nanotubes, and multi-walled carbon nanotubes. For example, when a slurry including the single-walled or double-walled carbon nanotubes among these is prepared, dispersion of the slurry may be improved, and excellent processibility such as coating and the like during formation of an active material layer may be achieved and, concurrently (e.g., simultaneously), improved conductivity of the active material layer formed by using the same may be achieved.

The carbon nanotubes may have a Raman R value in a range of about 0.8 to about 1.3.

Herein, the Raman R value refers to an intensity ratio (R=Id/Ig) obtained by a peak intensity (Ig) (G, about 1580 cm⁻¹) and a peak intensity (Id) (D, about 1350 cm⁻¹) in a Raman spectrum analysis.

When the carbon nanotubes included in the active material layer of the electrode for a rechargeable lithium battery according to this disclosure have the Raman R value within the foregoing range, dispersion of the carbon nanotubes in an active material is improved, and thus, an active material layer having excellent conductivity may be realized by using the active material. The Raman R value may be in a range of about 0.8 to about 1.3, for example, about 0.9 to about 1.1.

On the other hand, the nanocarbon may have an average particle diameter of about 5 nm to about 100 nm, for example, about 20 nm to about 50 nm. When the nanocarbon has an average particle diameter of greater than about 100 nm, resistance of an electrode manufactured by applying the active material layer including the same may be increased. In addition, when the nanocarbon has an average particle diameter of less than about 5 nm, an effect of improving conductivity may be insufficient. In other words, when the nanocarbon has an average particle diameter within the foregoing ranges, conductivity of the active material layer including the same may be improved, and concurrently (e.g., simultaneously), resistance of the electrode may be reduced.

In addition, the nanocarbon may have a specific surface area (SSA) of about 60 m²/g to about 1000 m²/g, for example, about 500 m²/g to about 800 m²/g. When the nanocarbon has a specific surface area within the foregoing ranges, resistance of an electrode plate may be reduced, and in addition, input and output characteristics and a cycle-life of a battery cell may be improved.

In the present specification, the specific surface area may be measured utilizing a nitrogen adsorption method or a BET (Brunauer Emmett Teller) method.

The carbon nanotubes and the nanocarbon may be mixed to have a weight ratio of about 3:1 to about 1:3. When the carbon nanotubes and the nanocarbon are mixed to be within the foregoing weight ratio range, high-rate charge and discharge characteristics, storage characteristics at a high temperature, and the like of a rechargeable lithium battery manufactured by using the same may be surprisingly improved.

Herein, as the carbon nanotubes have a longer average length, the weight ratio of mixing the carbon nanotubes and the nanocarbon may be decreased.

Accordingly, when the carbon nanotubes having an average length of greater than or equal to about 100 μm, for example, an average length in a range of about 100 μm to about 250 μm, the carbon nanotubes and the nanocarbon may be mixed to have a weight ratio of about 1:1 to about 1:3.

Hereinafter, an electrode for a rechargeable lithium battery including the active material layer may be used as a positive electrode.

The positive electrode includes a positive current collector and a positive active material layer disposed on the positive current collector.

The positive active material layer includes a positive active material in addition to the carbon nanotubes and the nanocarbon. In the rechargeable lithium battery, the average length of the carbon nanotubes may be maintained to be about 40 μm to about 250 μm, for example, about 70 μm to about 250 μm or about 100 μm to about 250 μm.

The positive active material may be a compound (lithiated intercalation compound) being capable of intercalating and deintercalating lithium, for example, one or more composite oxides of a metal selected from cobalt, manganese, nickel, and a combination thereof, and lithium. For example, the compounds represented by one of the following chemical formulae may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); and LiₐFePO₄ (0.90≤a≤1.8).

In the chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of the coating element, a hydroxide of the coating element, an oxyhydroxide of the coating element, an oxycarbonate of the coating element, and a hydroxyl carbonate of the coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be formed utilizing a method having no adverse influence on properties of a positive active material by using these elements in the compound. For example, the method may include any suitable coating method such as spray coating, dipping, and/or the like available in the art.

In the positive electrode, the content of the positive active material may be about 90 wt % to about 98.5 wt % based on the total weight of the positive active material layer.

On the other hand, the positive active material layer may further include a conductive material and may further include a binder as needed.

Herein, the conductive material may be a mixture of the carbon nanotubes and the nanocarbon.

When the conductive material includes the mixture of the carbon nanotubes and the nanocarbon, the total content thereof may be less than or equal to about 1.5 wt %, for example, about 0.2 wt % to about 1.5 wt % based on the total weight of the positive active material layer. When the mixture of carbon nanotubes and nanocarbon is included within the foregoing ranges, high-rate charge and discharge characteristics of a rechargeable lithium battery including the same may be improved and a cycle-life of a battery may be remarkably improved.

The conductive material is included to provide electrode conductivity.

In the embodiment, the mixture of carbon nanotubes and nanocarbon may be used as a conductive material of the positive active material layer.

Alternatively, or additionally, the conductive material including the mixture of carbon nanotubes and nanocarbon may be used in both a negative active material layer and a positive active material layer as needed or desired.

However, when the mixture of carbon nanotubes and nanocarbon is used as a conductive material only for a negative active material layer but not for a positive active material layer, a positive electrode may not include the conductive material but include an auxiliary conductive material to endow conductivity to an electrode, as needed or desired. The content of the auxiliary conductive material is the same (e.g., substantially the same) as that of a conductive material including the mixture of carbon nanotubes and nanocarbon.

In addition, such an auxiliary conductive material may be any suitable material having electronic conductivity unless it causes a chemical change (e.g., an undesirable chemical change) of a battery. Examples of the auxiliary conductive material may include a conductive material including a carbon-based material such as natural graphite, artificial graphite, carbon black, acetylene black, ketjen black, denka black, carbon fiber, and the like; a metal-based material of a metal powder or a metal fiber including such as copper, nickel, aluminum silver, and the like; a conductive polymer such as a polyphenylene derivative, and the like; or a mixture thereof.

However, in one embodiment, the carbon nanotubes and the nanocarbon may be desirably used as a conductive material of the positive active material layer.

On the other hand, the binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylidene fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. For example, in this disclosure, the binder included in the positive active material layer may be desirably polyvinylidene fluoride. When the polyvinylidene fluoride is used as the binder, a stable rechargeable lithium battery at a high voltage may be easily realized.

Herein, the content of the binder may be about 0.5 wt % to about 5 wt % based on the total weight of the positive active material layer.

The positive current collector may be an aluminum foil, a nickel foil, or a combination thereof, but the present disclosure is not limited thereto.

The positive active material layer is formed by mixing a positive active material, a binder, and a conductive material in a solvent to prepare an active material composition and coating the active material composition on a positive current collector. The method of forming the active material layer may be any suitable method available in the art. The solvent may include N-methylpyrrolidone and/or the like, but is not limited thereto.

The electrode for rechargeable lithium battery including the active material layer may be used as a negative electrode.

The negative electrode includes a negative current collector and a negative active material layer disposed on the negative current collector.

The negative active material layer includes a negative active material.

The negative active material may be a negative active material including silicon.

The negative active material including the silicon may be for example a silicon-carbon composite including crystalline carbon and a silicon particle. Herein, an average diameter (D50) of the silicon particle included in the silicon-carbon composite may be in a range of about 10 nm to about 200 nm. In addition, the silicon-carbon composite may include an amorphous carbon layer on at least one surface thereof. As used herein, when a definition is not otherwise provided, an average diameter (D50) of a particle indicates a diameter of a particle where an accumulated volume is about 50 volume % in a particle distribution.

The negative active material may include two or more kinds of the negative active materials. For example, a silicon-carbon composite as a first negative active material and crystalline carbon as a second negative active material may be included.

When the negative active material is prepared by mixing at least two kinds of negative active materials, a mixing ratio thereof may be suitably or appropriately adjusted, but an amount of Si may be adjusted to be in a range of about 1 wt % to about 50 wt % based on the total weight of the negative active material.

The negative active material layer includes a negative active material including a silicon-based material and a conductive material, and optionally a binder.

Herein, the conductive material may be the mixture of carbon nanotubes and nanocarbon. In the rechargeable lithium battery, the average length of the carbon nanotubes may be maintained to be about 40 μm to about 250 μm, for example, about 70 μm to about 250 μm or about 100 μm to about 250 μm.

In the negative active material layer, the content of the negative active material may be about 95 wt % to about 98 wt % based on the total weight of the negative active material layer.

The content of the conductive material including the mixture of the carbon nanotubes and the nanocarbon may be less than or equal to about 1.5 wt %, for example, about 0.2 wt % to about 1.5 wt %, based on the total weight of the negative active material layer.

When it further includes the binder, the content of the binder in the negative active material layer may be about 1 wt % to about 5 wt % based on the total weight of the negative active material layer.

The negative current collector may be selected from a copper foil, a nickel foil, a stainless steel foil, a titanium foil, a nickel foam, a copper foam, a polymer substrate coated with a conductive metal, and a combination thereof.

As described above, the conductive material including the mixture of the carbon nanotubes and the nanocarbon may be applied to both a positive active material layer and a negative active material layer. However, in the embodiment, the conductive material including the mixture of the carbon nanotubes and the nanocarbon may be applied to the positive active material layer.

Hereinafter, a rechargeable lithium battery including the electrode is described with reference to the accompanying drawing.

The accompanying drawing is a schematic view showing a structure of a rechargeable lithium battery according to an embodiment of this disclosure.

Referring to the accompanying drawing, a rechargeable lithium battery 100 according to according to an embodiment of this disclosure includes an electrode assembly 10, an exterior material 20 housing the electrode assembly 10, and a positive terminal 40 and a negative electrode terminal 50 electrically coupled to (e.g., electrically connected to) the electrode assembly 10.

The electrode assembly 10 may include a positive electrode 11, a negative electrode 12, a separator 13 disposed between the positive electrode 11 and the negative electrode 12, and an electrolyte solution impregnating the positive electrode 11, the negative electrode 12, and the separator 13.

Herein, at least one of the positive electrode 11 and the negative electrode 12 may be the electrode for the rechargeable lithium battery.

The features of the positive electrode 11 and the negative electrode 12 may be the same as described above, and thus, redundant description thereof is not repeated here.

On the other hand, the electrode assembly 10 as shown in the accompanying drawing, may have a structure obtained by interposing a separator 13 between band-shaped positive electrode 11 and negative electrode 12, spirally winding them, and compressing it flat. In addition, in some embodiments, a plurality of quadrangular sheet-shaped positive and negative electrodes may be alternately stacked with a plurality of separators therebetween.

In addition, the positive electrode 11, the negative electrode 12, and the separator 13 are impregnated in an electrolyte solution.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like and the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. In addition, the alcohol-based solvent may include ethanol, isopropyl alcohol, and the like and the aprotic solvent may include nitriles such as R—CN (wherein R is a hydrocarbon group having a C2 to C20 linear, branched, or cyclic structure and may include a double bond, an aromatic ring, or an ether bond), and the like, amides such as dimethyl formamide, and the like, dioxolanes such as 1,3-dioxolane, and the like, sulfolanes, and the like.

The non-aqueous organic solvent may be used alone or in a mixture. When the organic solvent is used in a mixture, the mixture ratio may be controlled in accordance with a suitable or desirable battery performance.

The carbonate-based solvent may include a mixture with a cyclic carbonate and a linear (chain) carbonate. The cyclic carbonate and linear carbonate are mixed together to a volume ratio of about 1:1 to about 1:9. When the mixture is used as an electrolyte, it may have enhanced performance.

The lithium salt dissolved in an organic solvent supplies a battery with lithium ions, basically operates the rechargeable lithium battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlC₄, LiN(CₓF₂ₓ₊₁SO₂)(C_{y}F_{2y+1}SO₂) (where x and y are natural numbers, i.e., an integer of 1 to 20), LiCl, LiI, and LiB(C₂O₄)₂ (lithium bis(oxalato) borate; LiBOB). A concentration of the lithium salt may be in a range of about 0.1 M to about 2.0 M. When the lithium salt is included at the above concentration range, an electrolyte may have excellent performance and lithium ion mobility due to suitable electrolyte conductivity and viscosity.

On the other hand, the separator 13 disposed between the positive electrode 11 and the negative electrode 12 may be a polymer film separating the positive electrode 11 from the negative electrode 12 and providing a transporting passage for lithium ions. The separator may have a low resistance to transportation of electrolyte ions and an excellent impregnation for an electrolyte solution and may be any suitable separator generally used in the art for a rechargeable lithium battery. For example, the separator 13 may be for example, selected from a glass fiber, polyester, polyethylene, polypropylene, polytetrafluoroethylene, or a combination thereof and may have a form of a non-woven fabric or a woven fabric. For example, a polyolefin-based polymer separator such as polyethylene, polypropylene, and the like is mainly used for a rechargeable lithium battery. In order to ensure the heat resistance or mechanical strength, a separator coated with a composition including a ceramic component or a polymer material may be used. Optionally, it may have a mono-layered or multi-layered structure.

The exterior material 20 may consist of a lower exterior material 22 and an upper exterior material 21, and the electrode assembly 10 is housed in an internal space 221 of the lower exterior material 22.

After housing the electrode assembly 10 in the exterior material 20, a sealant is applied on a sealing region 222 along the edge of the lower exterior material 22 to seal the upper exterior material 21 and the lower exterior material 22. Herein, parts where the positive terminal 40 and the negative electrode terminal 50 are in contact with the case 20 may be wrapped with an insulation member 60 to improve durability of the rechargeable lithium battery 100.

Hereinafter, the subject matter of the present disclosure will be described in more detail with respect to Examples. The present disclosure, however, is not limited to the Examples.

### Example 1

### (1) Manufacture of Positive Electrode

Carbon nanotubes which was multi-walled carbon nanotubes having a Raman R value of 0.9, an average length of 55 μm±5 μm, an average diameter of 17 nm, and a volume density (bulk density) of 0.05 g/cm³ were prepared.

Nanocarbon having an average particle diameter of 30 nm and a specific area of 700 m²/g to 800 m²/g was also prepared.

97 wt % of LiCoO₂ as a positive active material, 1 wt % of a conductive material including the carbon nanotubes and nanocarbon in a weight ratio of 3:1, and 2 wt % of polyvinylidene fluoride were mixed in N-methyl pyrrolidone to prepare a positive active material slurry. The positive active material slurry was coated on an aluminum foil and then, dried and compressed to manufacture a positive electrode.

### (2) Manufacture of Negative Electrode

Graphite, styrene-butadiene, and carboxylmethyl cellulose (CMC) in a weight ratio of 98:1:1 were added to water as a solvent to prepare a negative electrode slurry.

The negative electrode slurry was coated on a copper foil (a Cu foil) and then, dried and compressed to manufacture a negative electrode.

### (3) Manufacture of Rechargeable Lithium Battery Cell

The positive and negative electrodes according to the (1) and (2) and an electrolyte solution were used to manufacture a rechargeable lithium battery cell having a nominal capacity of 2400 mAh utilizing the same method. The electrolyte solution was prepared by using a mixed solvent of ethylene carbonate and diethyl carbonate (a volume ratio of 50:50) and dissolving 1.0 M LiPF₆ therein.

### Examples 2 to 4 and Comparative Examples 1 to 2

Each of positive electrodes, negative electrodes, and rechargeable lithium battery cells was manufactured according to substantially the same method as Example 1 except for adjusting properties of the carbon nanotubes and the nanocarbon, mixing weight ratios thereof, and contents of the conductive material including the same during manufacture of positive electrodes as shown in Table 1.

TABLE 1

| | Carbon nanotubes (CNT) | | | | | | |
|---|---|---|---|---|---|---|---|
| | | | Volume | | | | |
| | | | density | | Nanocarbon | | |
| | | average | of | | Average | Mixing | Conductive |
| | Average | diameter | particles | Raman | particle | weight ratio | material |
| | length | (unit: | (unit: | value | diameter | (CNT: | weight |
| | (unit: μm) | nm) | g/cm³) | (ld/lg) | (unit: nm) | nanocarbon) | (unit: wt %) |
| Example 1 | 55 ± 5 | 17 | 0.055 | 0.9 | 30 | 3:1 | 1 |
| Example 2 | 75 μm ± 5 | 15 | 0.042 | 0.98 | 30 | 2:1 | 1 |
| Example 3 | 120 μm ± 10 | 10 | 0.035 | 1.1 | 40 | 1:2 | 0.6 |
| Example 4 | 150 μm ± 10 | 10 | 0.015 | 1.1 | 40 | 1:2 | 0.6 |
| Comparative | — | — | — | — | 60 | 0:1 | 2 |
| Example 1 | | | | | | | |
| Comparative | 15 μm ± 5 | 50 | 0.1 | 0.75 | 30 | 1:1 | 1.3 |
| Example 2 | | | | | | | |

### Experimental Example 1: Measurement of Electrode Resistivity

Each of the positive electrodes according to Examples 1 to 4 and Comparative Examples 1 and 2 was cut into a set (e.g., predetermined) size of 32 Tr. Resistances of the cut positive electrodes were measured by using a LCR meter, 4294A made by Agilent Technologies and then, converted into resistivity. The results are shown in Table 2.

Referring to Table 2, the positive electrodes according to Examples 1 to 4 including long CNT and nanocarbon as a conductive material in a positive active material layer showed very low electrode specific resistivity of less than or equal to 20.

For example, the positive electrodes according to Examples 3 and 4 including CNT having an average length of greater than or equal to 100 μm showed very low electrode specific resistivity compared with those of the positive electrodes according to Examples 1 and 2.

However, the positive electrode according to Comparative Example 1 including only nanocarbon as a conductive material of the positive active material layer showed 7 times or greater high electrode resistivity compared with those of Examples. Furthermore, the positive electrode according to Comparative Example 2 including short CNT and nanocarbon as a conductive material of the positive active material layer even if it includes CNT and nanocarbon showed twice or greater high electrode resistivity compared with those of Examples.

Accordingly, when the battery cells according to the present Examples were used as a positive electrode for a rechargeable lithium battery, electrode specific resistivity was remarkably decreased.

### Experimental Example 2: Measurement of DC Internal Resistance (Direct Current, Internal Resistance: DC-IR)

DC internal resistance (DC-IR) of the rechargeable lithium battery cells according to Examples 1 to 4 and Comparative Examples 1 and 2 was measured according to the following method.

The rechargeable lithium battery cells were charged at a current of 0.2 C up to a voltage of SOC (a state of charge) of 70% (charged to have charge capacity of 70% based on 100% of the entire battery charge capacity) at the first circle under a constant current-constant voltage condition and the charging was cut off at 0.05 C.

Then, the rechargeable lithium battery cells were discharged at 0.2 C to SOC of 70% under a constant current condition and then, the discharging was cut off.

Subsequently, the rechargeable lithium battery cells were discharged at 2 C in SOC of 70% for 1 second under a constant current condition, and then, DC-IR was calculated by measure dV at 0.2 C and 2 C. The results are shown in Table 2.

Referring to Table 2, the rechargeable lithium battery cells according to Examples 1 to 4 showed, in general, lower DC-IR than that of the rechargeable lithium battery cells according to Comparative Examples 1 and 2.

Accordingly, when the battery cells according to the present Examples is used as a positive electrode for a rechargeable lithium battery, DC-IR of the battery may be effectively reduced.

### Experimental Example 3: Measurement of High-Rate Discharge and High-Rate Charge Characteristics

The rechargeable lithium battery cells according to Examples 1 to 4 and Comparative Examples 1 and 2 were once charged and discharged at 0.2 C to measure discharge capacity and then, at 2 C to measure charge and discharge capacities. Subsequently, charge and discharge efficiency of charge and discharge capacities at 2 C relative to charge and discharge capacities at 0.2 C was calculated and shown in Table 2.

Referring to Table 2, the rechargeable lithium battery cells according to Examples 1 to 4 showed improved high-rate discharge characteristics compared with the rechargeable lithium battery cells according to Comparative Examples 1 and 2.

Accordingly, when the electrodes according to the present Examples were used as a positive electrode for a rechargeable lithium battery, high-rate charge and discharge characteristics of the battery were remarkably improved.

### Experimental Example 4: Measurement of Storage Characteristics at High Temperature

The rechargeable lithium battery cells according to Examples 1 to 4 and Comparative Examples 1 and 2 were charged under a constant current condition at 2 C up to 4.3 V and a cut-off at 4.3 V up to SOC (State of Charge) of 100% (fully charged, charged to have charge capacity of 100% based on 100% of the entire battery charge capacity when charged and discharged from 2.8 V to 4.3 V) and then, stored at 60° C. for 4 weeks.

Subsequently, after stored for 4 weeks, thicknesses of the rechargeable lithium battery cells were measured by using a digital indicator, Model 543-490B made by Mitutoyo Corp., thicknesses of the rechargeable lithium battery cells before and after the storage were used to calculate their thickness increase rates (%), and then, the thickness increase rates are shown in Table 2.

Referring to Table 2, the rechargeable lithium battery cells including long CNT and nanocarbon as a conductive material of a positive active material layer according to Examples 1 to 4 showed a very excellent thickness increase rate of less than or equal to 22% after stored at a high temperature. On the contrary, the rechargeable lithium battery cell including nanocarbon alone as a conductive material of a positive active material layer according to Comparative Example 1 and the rechargeable lithium battery cell including short CNT and nanocarbon instead of long CNT as a conductive material of a positive active material layer according to Comparative Example 2 showed at least 1.5 times higher thickness increase rate after stored at a high temperature than the rechargeable lithium battery cells according to the present Examples.

Accordingly, when the electrodes according to the present Examples were used as a positive electrode of a rechargeable lithium battery, storage characteristics at a high temperature were remarkably improved.

### Experimental Example 5: Measurement of Room Temperature Cycle-Life

The rechargeable lithium battery cells according to Examples 1 to 4 and Comparative Examples 1 and 2 were repetitively 500 times charged and discharged by charging under a constant current-constant voltage condition of 0.7 C and 4.4 V and a cut-off condition of 0.025 C and allowed to stand for 10 minutes and then, discharging under a constant current of 1.0 C and a cut-off condition of 3.0 V and allowed to stand for 10 minutes at room temperature (25° C.), and then, discharge capacity of the rechargeable lithium battery cells were measured. Capacity retention of the battery cells was obtained by calculating discharge capacity at the 500th cycle relative to discharge capacity at the first cycle, and the results are shown in Table 2.

### Experimental Example 6: Measurement of High Temperature Cycle-Life

The rechargeable lithium battery cells according to Examples 1 to 4 and Comparative Examples 1 and 2 were 300 times repetitively charged and discharged by charging under a constant current-constant voltage of 0.7 C and 4.4 V and a cut-off condition of 0.025 C and allowed to stand for 10 minutes and then, discharging under a constant current condition of 1.0 C and a cut-off condition of 3.0 V at a high temperature of 45° C., and discharge capacity of the rechargeable lithium battery cells was measured. Capacity retention of the battery cells was obtained by calculating discharge capacity at the 300th cycle relative to discharge capacity at the first cycle, and the results are shown in Table 2.

Referring to Table 2, the rechargeable lithium battery cells according to Examples 1 to 4 showed very excellent cycle-life characteristics at room temperature and a high temperature compared with the rechargeable lithium battery cells according to Comparative Examples 1 and 2.

Accordingly, when the electrodes according to the present Examples were used as a positive electrode for a rechargeable lithium battery, cycle-life characteristics at room temperature and a high temperature were also effectively improved.

TABLE 2

| | | | | | Storage | | |
|---|---|---|---|---|---|---|---|
| | | | | | characteristics | | |
| | | | High-rate | High-rate | at a high | Room | High |
| | Electrode | | discharge | charge | temperature | temperature | temperature |
| | resistivity | DC- | characteristics | characteristics | (60° C., 4 | cycle-life | cycle-life |
| | (Ω/m) | IR | (2 C/0.2 C) | (2 C/0.2 C) | weeks) | @500 cycle | @300 cycle |
| Example 1 | 18 | 50 | 93.5% | 80.8% | 16.2% | 91.4% | 90.6% |
| Example 2 | 15 | 52 | 94.4% | 81.4% | 21.9% | 88.2% | 89.7% |
| Example 3 | 13 | 51 | 94.6% | 81.8% | 19.3% | 89.5% | 90% |
| Example 4 | 10 | 50 | 95.8% | 82.3% | 19.2% | 90.4% | 92.2% |
| Comparative | 130 | 59 | 80.9% | 70.1% | 45.4% | 85.6% | 83.8% |
| Example 1 | | | | | | | |
| Comparative | 42 | 57 | 88.7% | 79.0% | 34.7% | 87.8% | 86.8% |
| Example 2 | | | | | | | |

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element(s) or feature(s) as illustrated in the FIGURES. It will be understood that the spatially relative terms are intended to encompass different orientations of the device in use or in operation, in addition to the orientation depicted in the FIGURES. For example, if the device in the FIGURES is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. As used herein, the term “and/or” includes any and all combinations of one or more of the associated listed items. Expressions such as “at least one of,” when preceding a list of elements, modify the entire list of elements and do not modify the individual elements of the list.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the subject matter of the present disclosure has been described in connection with what is presently considered to be practical example embodiments, it is to be understood that the presented disclosure is not limited to the disclosed embodiments, but, on the contrary, is intended to cover various modifications and equivalent arrangements included within the spirit and scope of the appended claims, and equivalents thereof.

### DESCRIPTION OF SOME OF THE SYMBOLS

100: rechargeable lithium battery
11: positive electrode
12: negative electrode
13: separator
20: exterior material

What is claimed is:

1. An electrode for a rechargeable lithium battery, the electrode comprising:
a current collector; and
an active material layer on the current collector and comprising an active material, carbon nanotubes, and nanocarbon,
wherein the carbon nanotubes have an average length of about 40 μm to about 250 μm, and
the nanocarbon has an average particle diameter of about 5 nm to about 100 nm.

2. The electrode of claim 1, wherein the carbon nanotubes have an average length of about 70 μm to about 250 μm.

3. The electrode of claim 1, wherein the carbon nanotubes have an average length of about 100 μm to about 250 μm.

4. The electrode of claim 1, wherein the carbon nanotubes have an average diameter of about 1 nm to about 20 nm.

5. The electrode of claim 1, wherein the carbon nanotubes have a volume density of less than or equal to about 0.1 g/cm³.

6. The electrode of claim 1, wherein the carbon nanotubes comprise one or more selected from the group consisting of single-walled carbon nanotubes, double-walled carbon nanotubes, and multi-walled carbon nanotubes.

7. The electrode of claim 1, wherein the carbon nanotubes have a Raman R value of about 0.8 to about 1.3
wherein the Raman R value refers to an intensity ratio R=Id/Ig, Ig being a peak intensity G at about 1580 cm⁻¹, and Id being a peak intensity D at about 1350 cm⁻¹ in a Raman spectrum analysis.

8. The electrode of claim 7, wherein the Raman R value is in a range of about 0.9 to about 1.1.

9. The electrode of claim 1, wherein the nanocarbon has a specific surface area of about 60 m²/g to about 1000 m²/g.

10. The electrode of claim 1, wherein a weight ratio of the carbon nanotubes to the nanocarbon is in a range of about 3:1 to about 1:3.

11. The electrode of claim 1, wherein the total weight of the carbon nanotubes and the nanocarbon is less than or equal to about 1.5 wt % based on the total weight of the active material layer.

12. The electrode of claim 1, wherein the active material is a positive active material.

13. The electrode of claim 1, wherein the active material is a negative active material.

14. The electrode of claim 13, wherein the negative active material comprises silicon.

15. A rechargeable lithium battery, comprising:
a positive electrode;
a negative electrode;
a separator between the positive electrode and the negative electrode; and
an electrolyte solution,
wherein at least one selected from the group consisting of the positive electrode and the negative electrode is the electrode of claim 1.

16. The rechargeable lithium battery of claim 15, wherein the positive electrode is the electrode of claim 1.
